(19) United States
(12) Patent Application Publication
(10) Pub. No.: US 2012/0137284 A1
(43) Pub. Date: May 31, 2012

(54) METHOD FOR INSTALLING IMAGE FILE

(75) Inventors: Lian-Cheng Li, Tianjin (CN); Chih-Feng Chen, Taipei (TW)

(73) Assignee: INVENTEC CORPORATION, Taipei (TW)

(21) Appl. No.: 13/070,104

(22) Filed: Mar. 23, 2011

(30) Foreign Application Priority Data
Nov. 30, 2010 (CN) 201010589570.0

(51) Int. Cl. G06F 9/445

(52) U.S. Cl. 717/178

(57) ABSTRACT

An installing method for an image file is capable of more effectively installing the image file in a computer. The installing method includes the following steps that a wire network connection between the computer and an image file server is made; the image file is downloaded from the image file server to the computer by using the wire network connection; the wire network connection is closed, and the image file is decompressed and installed to the computer; a wireless network connection between the computer and the image file server is made; and an installation result and an install log of the computer are returned by using the wireless network connection.

### CROSS-REFERENCE TO RELATED APPLICATIONS

This non-provisional application claims priority under 35 U.S.C. §119(a) on Patent Application No(s). 201010589570.0 filed in China, P.R.C. on Nov. 30, 2010, the entire contents of which are hereby incorporated by reference.

### FIELD OF THE INVENTION

The present invention relates to a method for installing an image file, and more particularly to a method capable of effectively installing an image file.

### BACKGROUND OF THE INVENTION

No matter being a notebook computer, a large-scale server, or a smart phone, a computer before being provided to a user needs to be installed with an operating system (OS) for the use of the user, or it is necessary to provide a navigation disk or a maintenance disk having the OS for the user. Thus, computer manufacturers are required to install the OS to computers in bulk before shipment. When the OS is installed, each computer requires a corresponding image file.

Currently, a common method used in the industry is to carry out fully automatic installation on a large quantity of machines at the same time through a network by using backup and restore tools. It is necessary for each computer to download the required image file from a server and to install the downloaded image file. As the image file has a large file size, it is necessary to download the image file in a high-speed and stable wire network environment. After the image file is obtained, it takes the computer a long time to decompress and install the obtained image file before uploading a final result and a log file to a management system. Although network resources are not required during the decompression and installation, each computer still continuously occupies a network point in the limited network equipment resources, which causes a waste of the network point.

### SUMMARY OF THE INVENTION

Accordingly, the present invention provides a method for installing an image file, which is applicable to installing at least one image file in at least one computer. The method for installing the image file comprises: making a wire network connection between the computer and an image file server; downloading an image file from the image file server to the computer by using the wire network connection; closing the wire network connection, and decompressing and installing the image file to the computer; making a wireless network connection between the computer and the image file server; and returning an installation result and an install log of the computer by using the wireless network connection.

The step of closing the wire network connection, and decompressing and installing the image file to the computer may comprise: closing the wire network connection; switching the computer from a first position to a second position, in which the second position is incapable of making the wire network connection; and decompressing and installing the image file to the computer.

Before the step of decompressing and installing the image file to the computer, the method for installing the image file may further comprise: resetting the computer. Between the step of closing the wire network connection, and decompressing and installing the image file to the computer, and the step of making the wireless network connection between the computer and the image file server, the method for installing the image file may also comprise: resetting the computer.

In addition, the computer may further download at least one language pack or at least one patch from the image file server to the computer for installation through the wire network connection.

The wire network connection in the above description may use an optical fiber, a coaxial cable, a twisted pair wire, or a power line to connect the computer and the image file server; and the wireless network connection in the above description may use Bluetooth, Wireless Fidelity (Wi-Fi) (IEEE 802.11a/b/g/n), or Worldwide Interoperability for Microwave Access (WiMAX) (IEEE 802.11a/b/g/n) to connect the computer and the image file server.

To sum up, in the method for installing an image file, the image file is downloaded through the wire network connection; and the image file is decompressed and installed after the network point occupied by the wire network connection is released. After the installation is completed, the wireless network connection is used for transmitting the installation result and the install log having a small data volume. Therefore, the method for installing the image file can save a large quantity of time spent in occupying the network point, thus greatly improving the operating efficiency.

These and other aspects of the present invention will become apparent from the following description of the preferred embodiment taken in conjunction with the following drawings, although variations and modifications therein may be affected without departing from the spirit and scope of the novel concepts of the disclosure.

### BRIEF DESCRIPTION OF THE DRAWINGS

The accompanying drawings illustrate one or more embodiments of the invention and, together with the written description, serve to explain the principles of the invention. Wherever possible, the same reference numbers are used throughout the drawings to refer to the same or like elements of an embodiment, and wherein:

FIG. 1 is a flow chart of a method for installing an image file according to an embodiment;

FIG. 2 is a schematic view of a wire network connection according to an embodiment;

FIG. 3 is a flow chart of Step S130 according to an embodiment; and

FIG. 4 is a schematic view of a wireless network connection according to an embodiment.

### DESCRIPTION OF THE EMBODIMENTS

The detailed features and advantages of the present invention are described below in great detail through the following embodiments, and the content of the detailed description is sufficient for those skilled in the art to understand the technical content of the present invention and to implement the present invention accordingly. Based upon the content of the specification, the claims, and the drawings, those skilled in the art can easily understand the relevant objectives and advantages of the present invention.

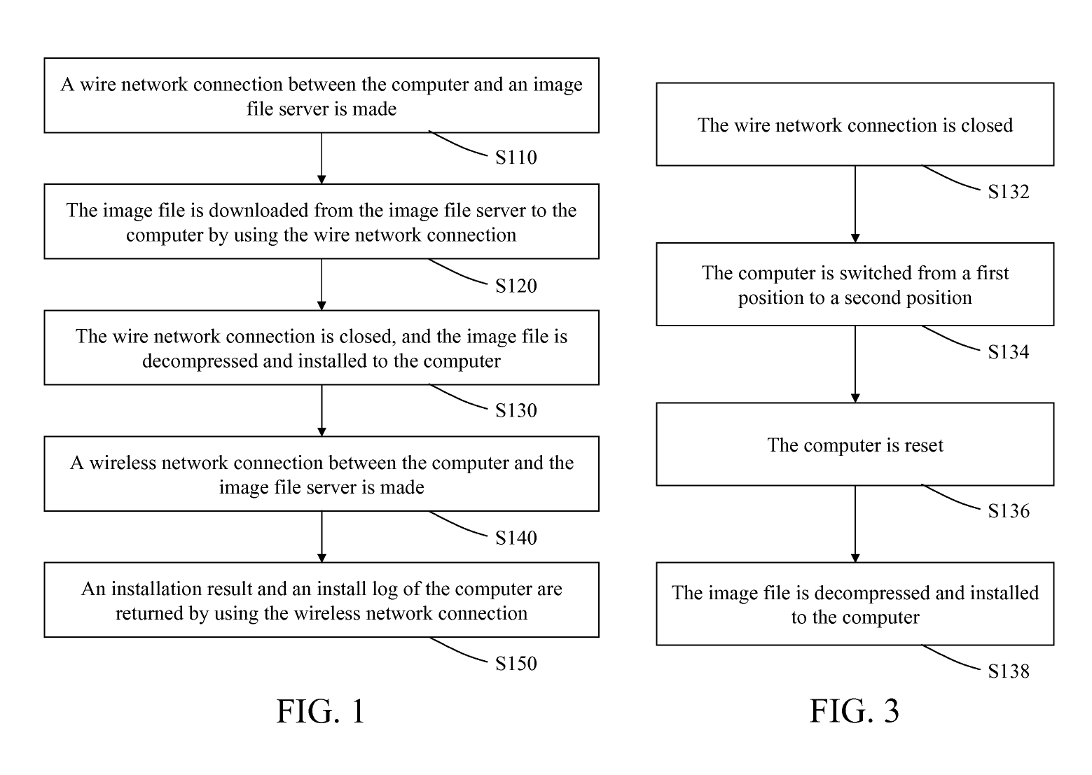

In order to effectively install a plurality of computers, a method for installing an image file is provided. The method for installing the image file may install at least one image file in at least one computer, so as to install resources such as an Operating System (OS) or various application programs in the computer. The method for installing the image file may be implemented as a daemon running in each computer. FIG. 1 is a flow chart of a method for installing an image file according to an embodiment.

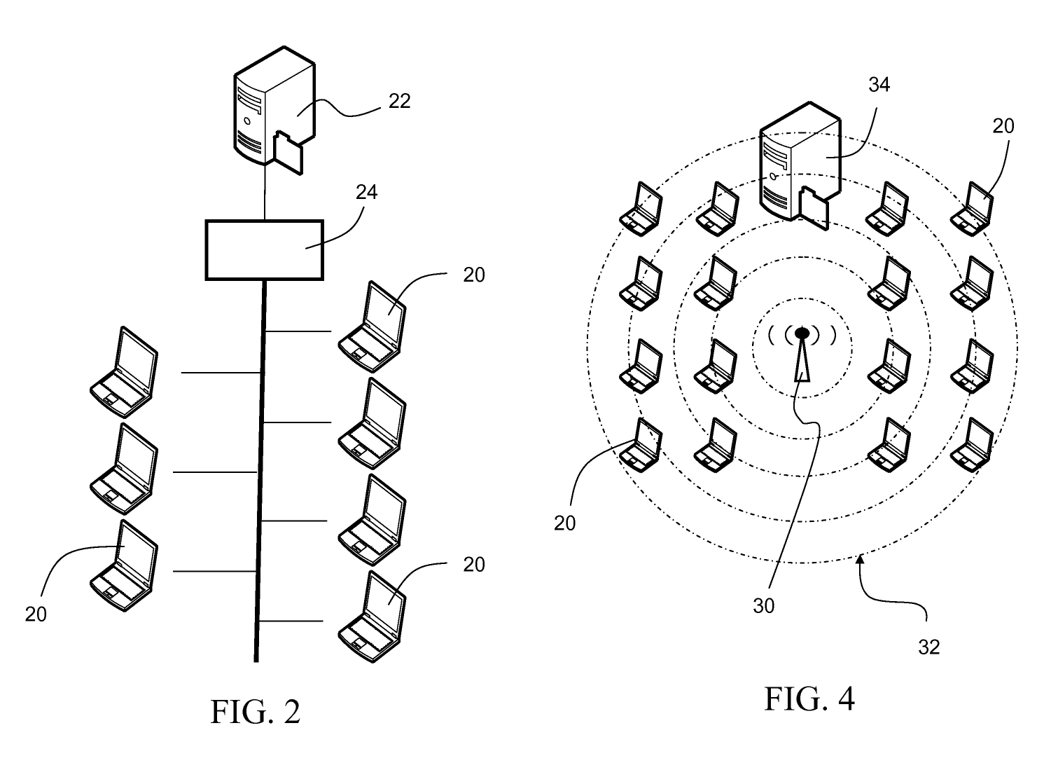

Referring to FIG. 1, in order to download the image file, firstly, a wire network connection between the computer and an image file server is made (Step S110). FIG. 2 is a schematic view of a wire network connection according to an embodiment.

Referring to FIG. 2 at the same time, each computer 20 is connected with the image file server 22 through the wire network connection. Between the computers 20 and the image file server 22 may be a switch 24 or a router for constructing the wire network connection under actual space conditions.

The computer 20 may comprise hardware such as a central processor unit (CPU), a memory, and a storage device. The computer 20 may be various computer systems such as a desktop computer, a notebook computer, a server, a personal digital assistant (PDA), or a smart phone, which is not limited herein. The storage device may be, for example, various large-capacity hard disks, a redundant array of inexpensive disk (RAID) system, or a built-in hard disk of a portable device.

The image file refers to a file type such as an International Organisation for Standardisation (ISO) 9660 file system or Microsoft Windows Imaging (WIM). The content of the image file may be a kernel program of the OS to be installed, for example, a kernel program corresponding to a Windows XP system or a Windows 7 system. The image file server 22 may comprise image files corresponding to various installation requirements so as to satisfy possible needs of the computers 20.

The wire network connection may use an optical fiber, a coaxial cable, a twisted pair wire, or a power line to connect the computer 20 and the image file server 22, and may also use various network communication protocols such as transport layer protocol (TCP), User Datagram Protocol (UDP), or Internet Protocol (IP).

Then, the image file is downloaded from the image file server 22 to the computer 20 by using the wire network connection (Step S120). In addition, the computer 20 may further download at least one language pack or at least one patch from the image file server 22 to the computer 20 for installation through the wire network connection according to the installation requirements. However, the extra downloaded files can also be obtained from other servers through the wire network connection.

After the downloading of various files required for the installation such as the image file is completed, the wire network connection is closed, and the image file is decompressed and installed to the computer 20 (Step S130). FIG. 3 is a flow chart of Step S130 according to an embodiment.

Referring to FIG. 1 and FIG. 3, as the computer 20 does not need to download any file from the image file server 22, the wire network connection is closed (Step S132). The computer 20 can be switched from a first position to a second position (Step S134), in which the second position is incapable of making the wire network connection. When the wire network is used for communication, each computer 20 occupies a physical network connection port (hereinafter referred to as a network point). In Step S134, the computer 20 completing the downloading operation can be moved from the first position connected with the network point to the second position incapable of being connected with the network point.

Then, the computer 20 may be reset automatically (Step S136), and the image file is decompressed and installed to the computer 20 (Step S138). If the computer 20 has selectively downloaded other patches, language packs, or installation files of application programs, the decompression and installation thereof can be performed together in this step. According to the installation of the image file and the files selectively downloaded, the method for installing the image file generates an installation result and an install log. The installation result may be a simple flag used for indicating whether the installation is completed or whether the installation fails. A downloading list, an installation state, an installation time, or other parameters of all the downloaded files may be recorded in the install log.

After the assembly and installation of the image file are completed, a wireless network connection between the computer 20 and the image file server 22 is made (Step S140). FIG. 4 is a schematic view of a wireless network connection according to an embodiment.

Referring to FIG. 4, a wireless network range 32 can be constructed by using at least one wireless base station 30. A log server 34 and all computers 20 in the wireless network range 32 can use the wireless network connection. More specifically, the computer 20 is moved to the second position within the wireless network range 32 in Step S134, and the computer 20 can be reset automatically or manually. The computer 20 is then enabled to use the wireless network function and to establish the wireless network connection with the log server 34. The wireless network connection may use Bluetooth, Wi-Fi (IEEE 802.11a/b/g/n), or WiMAX (IEEE 802.11a/b/g/n) to connect the computer 20 and the log server 34.

After the wireless network connection is established, the installation result and the install log of the computer 20 are returned by using the wireless network connection (Step S150) so as to complete the entire procedure of installing the image file.

In one embodiment, the log server 34 is the image file server 22 to receive the installation result and the install log, and the image file server 22 can make the wire network connection and the wireless network connection. In another embodiment, the log server 34 differs from the image file server 22, but receives the installation result and the install log instead of the image file server 22.

To sum up, in the method for installing the image file, the stable wire network connection having a high transmission rate is used during the transmission of the image file, uses, and during the decompression and installation of the image file, the computer is transferred to the second position not requiring the wire network connection so that the originally occupied network point is released for use by other computers which have not downloaded image files. After the installation is completed, the wireless network connection which can be configured conveniently is used for transmitting the installation result and the install log having a small data volume.

In practice, about 20 to 40 minutes are required to download the image file; about 40 to 80 minutes are required to decompress and install the image file; and only about one minute is required to return the installation result and the install log. Therefore, the method for installing the image file can save the time spent in occupying the network point in the installation stage by the conventional method, thus greatly improving the operating efficiency.

What is claimed is:

1. A method for installing an image file, applicable to installing at least one image file in at least one computer, the method comprising:
making a wire network connection between the computer and an image file server;
downloading the image file from the image file server to the computer by using the wire network connection;
closing the wire network connection, and decompressing and installing the image file to the computer;
making a wireless network connection between the computer and the image file server; and
returning an installation result and an install log of the computer by using the wireless network connection.

2. The method for installing the image file according to claim 1, wherein the step of closing the wire network connection, and decompressing and installing the image file to the computer comprises:
closing the wire network connection;
switching the computer from a first position to a second position, wherein the second position is incapable of making the wire network connection; and
decompressing and installing the image file to the computer.

3. The method for installing the image file according to claim 2, wherein before the step of decompressing and installing the image file to the computer, the method for installing the image file further comprises:
resetting the computer.

4. The method for installing the image file according to claim 1, wherein between the step of closing the wire network connection, and decompressing and installing the image file to the computer, and the step of making the wireless network connection between the computer and the image file server, the method for installing the image file further comprises:
resetting the computer.

5. The method for installing the image file according to claim 1, wherein the computer further downloads at least one language pack or at least one patch from the image file server to the computer for installation through the wire network connection.

6. The method for installing the image file according to claim 1, wherein the wire network connection uses an optical fiber, a coaxial cable, a twisted pair wire, or a power line to connect the computer and the image file server.

7. The method for installing the image file according to claim 1, wherein the wireless network connection uses Bluetooth, Wireless Fidelity (Wi-Fi), or Worldwide Interoperability for Microwave Access (WiMAX) to connect the computer and the image file server.
